(19) United States
(12) Patent Application Publication
(10) Pub. No.: US 2007/0216688 A1
(43) Pub. Date: Sep. 20, 2007

(54) Display program, data structure and display device

(75) Inventors: Takashi Sawazaki, Chofu (JP); Yoshiyuki Ono, Hino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/705,894

(22) Filed: Feb. 13, 2007

(30) Foreign Application Priority Data
Mar. 16, 2006 (JP) 2006-073088

(51) Int. Cl. G06T 11/00

(52) U.S. Cl. 345/467

(57) ABSTRACT

A display program for displaying a character by acquiring an instruction for rendering each element composing the character and rendering the element based on the instruction, the program being executed on a computer includes a setting function of setting a method of handling an argument associated with the later acquired instruction in accordance with a rendering mode corresponding to a mode setting instruction if the mode setting instruction for setting the rendering mode is acquired, and a display function of displaying the character by handling the argument in accordance with the setting result by the setting function.

The entire disclosure of Japanese Patent Application No. 2006-073088, filed Mar. 16, 2006 is expressly incorporated by reference herein.

### BACKGROUND

1. Technical Field

The present invention relates to a display program, a data structure and a display device for displaying a character based on an instruction for rendering each element composing the character by acquiring the instruction.

2. Related Art

Conventionally, as a technique of this kind, a display program is well known in which if either an instruction for handling the associated argument (coordinate value) as represented in the relative coordinate or an instruction for handling the coordinate value as represented in the absolute coordinate is acquired, the coordinate value associated with the instruction is handled in a form according to the instruction (e.g., refer to “http://partners.adobe.com/public/developer/en/font/T1_SP EC.PDF”).

With such technique, typically, the data amount of rendering instruction data (data including a plurality of segments) is compressed by allocating an optimal compression sign according to the occurrence rate to the segment consisting of a combination of the instruction and the argument associated with the instruction.

### SUMMARY

However, with the prior art, since the instruction of handling the associated argument as relative coordinate and the instruction of handling it as absolute coordinate are prepared as different instructions, there is a risk that the number of kinds of instructions is increased, so that the compression ratio of rendering instruction data is decreased.

The invention has been achieved to solve the unsolved problems with the prior art, and it is an object of the invention to provide a display program, a data structure and a display device in which the compression ratio of rendering instruction data can be improved.

In order to accomplish the above object, the present invention provides a display program for displaying a character by acquiring an instruction for rendering each element composing the character and rendering the element based on the instruction, the program being executed on a computer, characterized by comprising a setting function of setting a method of handling an argument associated with the later acquired instruction in accordance with a rendering mode corresponding to a mode setting instruction if the mode setting instruction for setting the rendering mode is acquired, and a display function of displaying the character by handling the argument in accordance with the setting result by the setting function.

Also, the argument may be a coordinate value, and the rendering modes may include a mode of handling the newly acquired coordinate value as represented in relative coordinate with the coordinate value at the end point of the immediately previous rendered element and a mode of handling the newly acquired coordinate value as represented in absolute coordinate, wherein the setting function may involve setting the handling method to handle the coordinate value associated with the later acquired instruction to be represented in any one form of the relative coordinate and the absolute coordinate.

Further, the argument may be the coordinate value, and the rendering modes may include a mode of handling the newly acquired coordinate value to be represented in the integral part alone, and a mode of handling the newly acquired coordinate value to be represented in a set of integral part and decimal part, wherein the setting function may involve setting the handling method to handle the coordinate value associated with the later acquired instruction to be represented in any one form of the integral part alone and the set of integral part and decimal part.

Also, the argument may be the coordinate value, and the rendering modes may include a mode of handling the newly acquired coordinate value to be represented in a low compression coordinate designation, and a mode of handling the newly acquired coordinate value to be represented in a high compression coordinate designation, wherein the setting function may involve setting the handling method to handle the coordinate value associated with the later acquired instruction to be represented in any one form of the low compression coordinate designation and the high compression coordinate designation.

Moreover, the invention provides a data structure for use in a display program for displaying a character by acquiring an instruction for rendering each element composing the character and rendering the element based on the instruction, characterized in that a mode setting instruction for setting a rendering mode is arranged before the instruction for handling an argument in accordance with the rendering mode.

Also, the invention provides a display device for displaying a character by acquiring an instruction for rendering each element composing the character and rendering the element based on the instruction, characterized by comprising a setting section for setting a method of handling an argument associated with the later acquired instruction in accordance with a rendering mode corresponding to a mode setting instruction if the mode setting instruction for setting the rendering mode is acquired, and a display section for displaying the character by handling the argument in accordance with the setting result by the setting section.

With this constitution, for example, the instruction for handling the associated coordinate value to be represented in relative coordinate (or integral part alone) and the instruction for handling the associated coordinate value to be represented in absolute coordinate (or a set of integral part and decimal part) can be the same instruction, whereby the number of kinds of instructions is reduced, so that the compression ratio of rendering instruction data can be improved.

Moreover, in the display program of the invention, if the coordinate value associated with the later acquired instruction is handled to be represented in the set of integral part and decimal part, the handling method may be set to handle the coordinate value associated with the later acquired instruction to be allocated more bit width when it is handled to be represented in the set of integral part and decimal part than when it is handled to be represented in the integral part alone.

With this constitution, for example, the coordinate value associated with the instruction can be allocated more bit width by acquiring the mode setting instruction for setting the rendering mode of handling the coordinate value to be represented in the set of integral part and decimal part before acquiring the instruction for rendering the graphic, whereby the intricate graphic can be rendered without changing the scaling factor in rendering the graphic on the entire display body. Also, it is unnecessary that the straight line or Bezier curve composing the graphic is divided, for example, so that an increase in the total number of mnemonics is prevented.

### BRIEF DESCRIPTION OF THE DRAWINGS

FIG. 1 is a block diagram showing the internal configuration of a display device according to one embodiment of the present invention;

FIG. 2 is an explanatory view for explaining the mode setting mnemonics;

FIG. 3 is an explanatory view for explaining the handling of the element correspondent mnemonics after acquiring ChangeRelInt;

FIG. 4 is an explanatory view for explaining the handling of the element correspondent mnemonics after acquiring ChangeAbsInt;

FIG. 5 is an explanatory view for explaining the handling of the element correspondent mnemonics after acquiring ChangeRelFix;

FIG. 6 is an explanatory view for explaining the handling of the element correspondent mnemonics after acquiring ChangeAbsFix;

FIG. 7 is a flowchart showing the flow of a character rendering process;

FIG. 8 is a flowchart showing the flow of a bit map generation process;

FIG. 9 is a flowchart showing the flow of a contour data generation process;

FIG. 10 is an explanatory view for explaining the operation of this embodiment;

FIG. 11 is an explanatory view for explaining the operation of this embodiment;

FIG. 12 is a flowchart showing the flow of a RelInt rendering instruction generation process;

FIG. 13 is a flowchart showing the flow of a RelInt instruction store process;

FIG. 14 is a flowchart showing the flow of an AbsInt rendering instruction generation process; and

FIG. 15 is a flowchart showing the flow of an AbsInt instruction store process.

### DETAILED DESCRIPTION OF THE PREFERRED EMBODIMENTS

A display device according to one embodiment of the present invention will be described below with reference to the drawings.

### First Embodiment

Configuration of Display Device

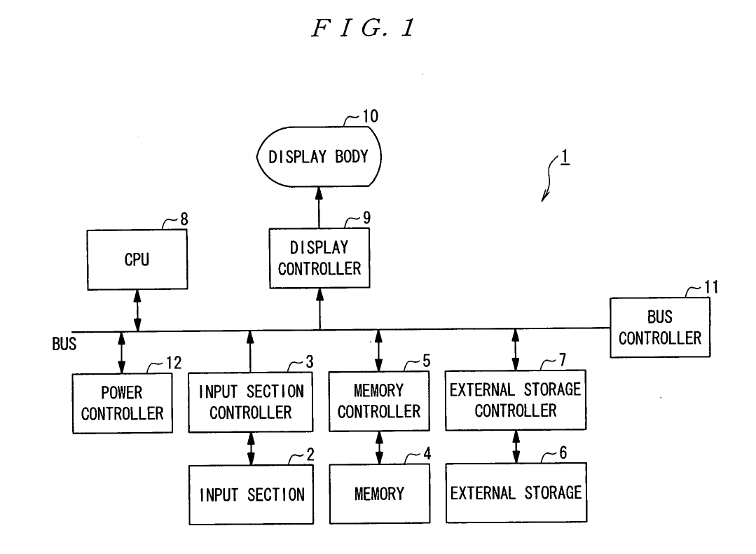

FIG. 1 is a block diagram showing the internal configuration of the display device according to one embodiment of the invention. The display device 1 comprises an input section 2, an input section controller 3, a memory 4, a memory controller 5, an external storage 6, an external storage controller 7, a CPU 8, a display controller 9, a display body 10, a bus controller 11 and a power source controller 12, as shown in FIG. 1.

The input section 2 is a device such as a mouse or a keyboard that is manipulated to instruct the rendering of character. And the input section 2 outputs a character rendering instruction via the input section controller 3 to the CPU 8, if an operation for instructing the rendering of character is made.

The input section controller 3 controls the data transfer between the input section 2 and the CPU 8.

The memory 4 is formed with a work area for expanding various kinds of program when the CPU 8 executes the program, and a storage area for storing the data related with various kinds of program executed by the CPU 8 and the data of information to be displayed.

The memory controller 5 controls the data transfer between the memory 4 and the CPU 8.

The external storage 6 stores various kinds of program such as a basic control program or an application program executed by the CPU 8 and the data related with various kinds of program.

The external storage controller 7 controls the data transfer between the external storage 6 and the CPU 8.

The CPU 8 controls each of the sections 2 to 12 by reading various kinds of program stored in the external storage 6, and expanding it over the work area formed in the memory 4.

Specifically, the CPU 8 performs a character rendering process, if a character rendering instruction is outputted from the input section 2. And in the character rendering process, the rendering instruction data (data composed of a plurality of mnemonics (data representing a combination of instruction and argument associated with the instruction) for rendering each element composing the character, or the data in which the mnemonics are arranged in a prescribed order) is acquired based on the character code of the character, the mnemonics are acquired one by one in the prescribed order from the rendering instruction data, and a bit map of the rendering instructed character is generated based on the mnemonics.

If the mnemonic (mode setting mnemonic) for setting the rendering mode is acquired, the CPU 8 sets up a method for handling the coordinate value (bit string) contained in the mnemonic (element correspondent mnemonic) corresponding to each element composing the rendering instructed character acquired later in accordance with the mode setting mnemonic.

That is, the mnemonics making up the rendering instruction data have the mnemonics for handling the coordinate value in accordance with the rendering mode after the mode setting mnemonic.

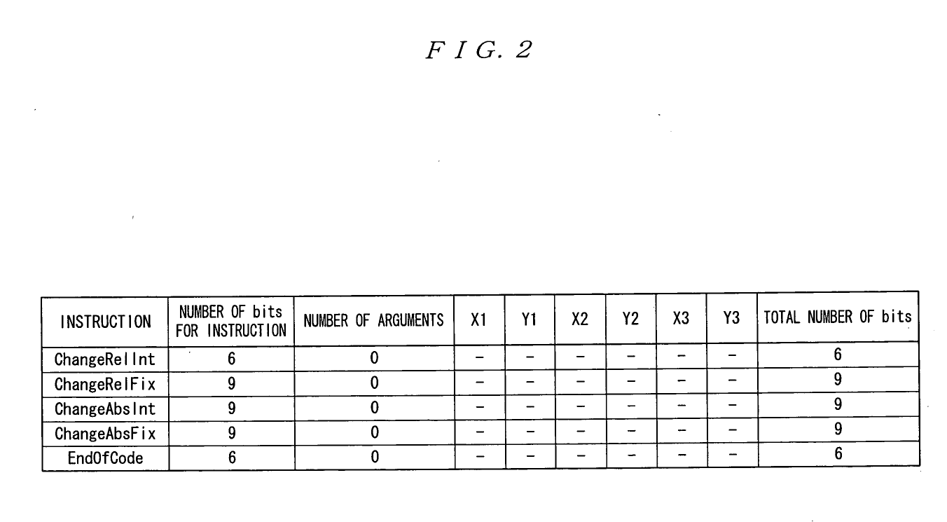

Herein, the mode setting mnemonics include ChangeRelInt, ChangeRelFix, ChangeAbsInt and ChangeAbsFix, as shown in FIG. 2.

ChangeRelInt instructs to handle the coordinate value of element correspondent mnemonic as representing the relative coordinate with the coordinate value at the end point of immediately previous rendered element in the integral form (form including the integral part alone).

ChangeRelFix instructs to handle the coordinate value of element correspondent mnemonic as representing the relative coordinate with the coordinate value at the end point of immediately previous rendered element in the decimal form (form including both the integral part and the decimal part).

ChangeAbsInt instructs to handle the coordinate value of element correspondent mnemonic as representing the absolute coordinate in the integral form.

ChangeAbsFix instructs to handle the coordinate value of element correspondent mnemonic as representing the absolute coordinate in the decimal form.

In FIG. 2, EndOfCode is a code indicating the last mnemonic making up the rendering instruction data.

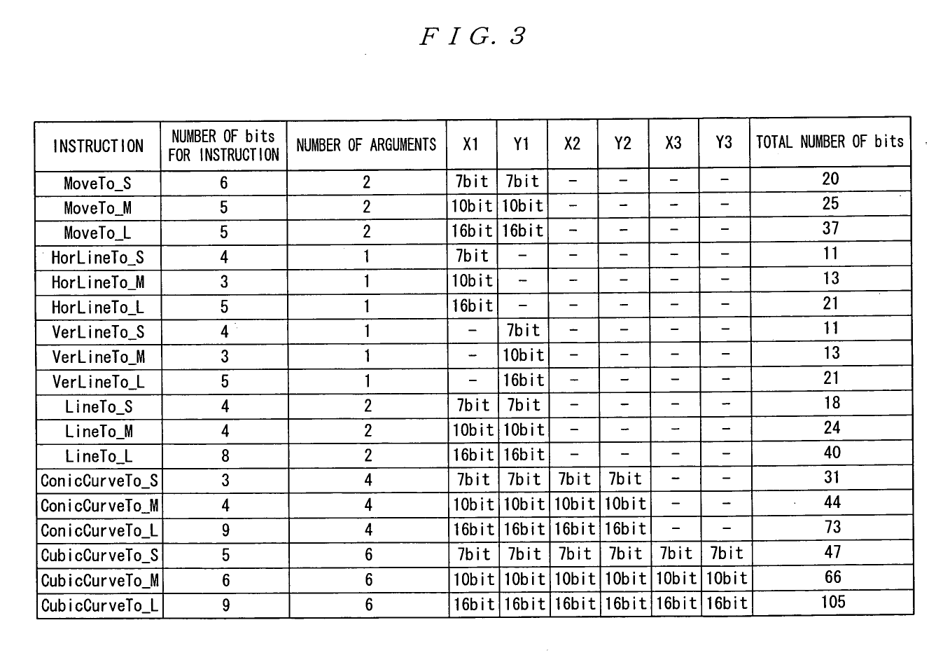

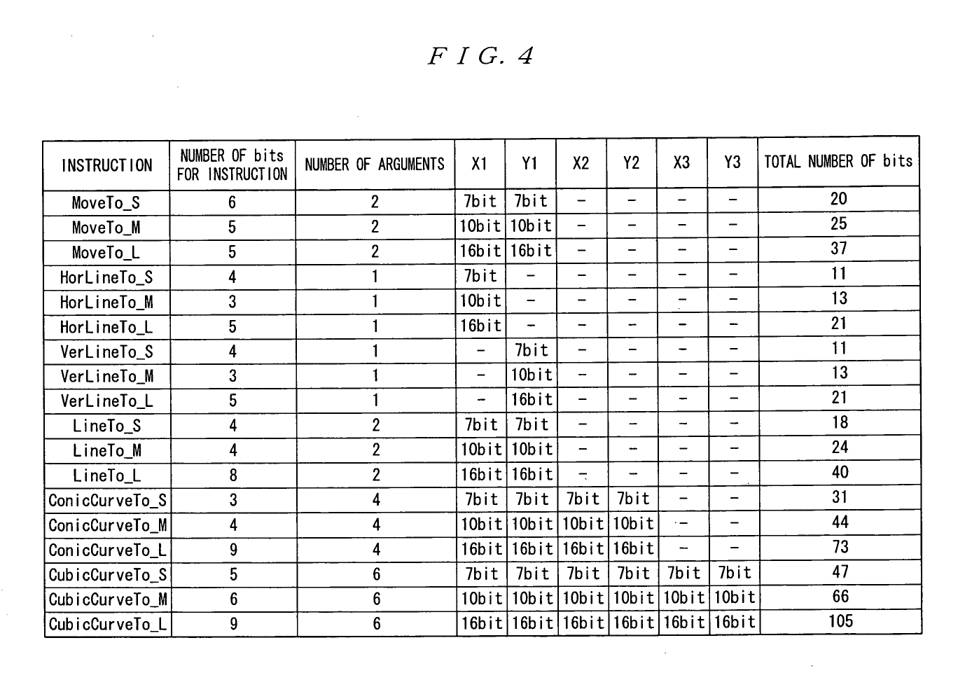

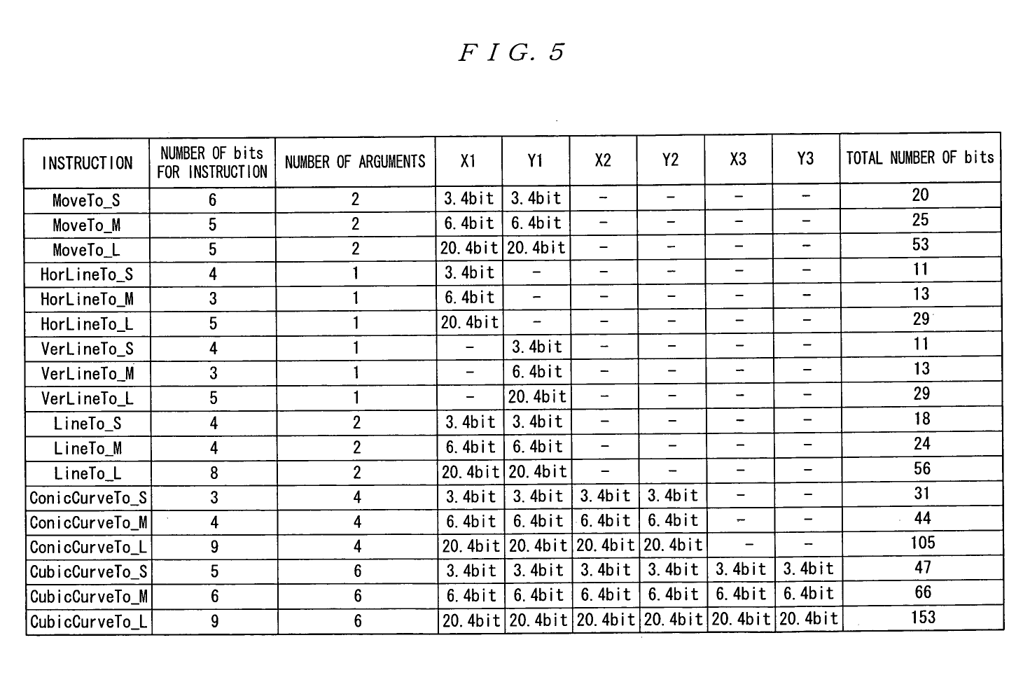

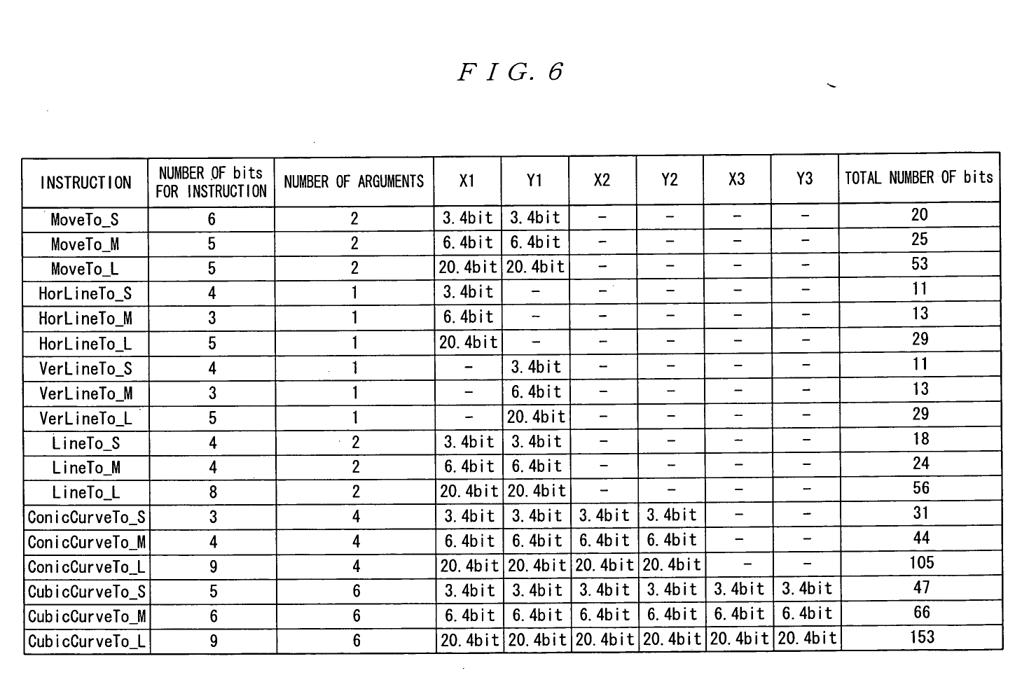

Also, the element correspondent mnemonics include MoveTo_S, MoveTo_M, MoveTo_L, HorLineTo_S, HorLineTo_M, HorLineTo_L, VerLineTo_S, VerLineTo_M, VerLineTo_L, LineTo_S, LineTo_M, LineTo_L, ConicCurveTo_S, ConicCurveTo_M, ConicCurveTo_L, CubicCurveTo_S, CubicCurveTo_M and CubicCurveTo_L, as shown in FIGS. 3 to 6.

MoveTo_S, MoveTo_M and MoveTo_L are codes including the number of arguments (2) and the coordinate value (X1,Y1). And if the lastly read mode setting mnemonic is ChangeRelInt or ChangeRelFix, they instruct to move the relative coordinate with the end point of immediately previous rendered element to the point of the coordinate value (X1,Y1) Also, if the lastly read mode setting mnemonic is ChangeAbsInt or ChangeAbsFix, they instruct to move it to the coordinate value (X1,Y1) in the absolute coordinate system.

In this embodiment, the origin of the absolute coordinate is set at an upper left corner on the display body 10, the X axis is formed in a right direction in plan view, and the Y axis is formed in a lower direction in plan view.

HorLineTo_S, HorLineTo_M and HorLineTo_L are codes including the number of arguments (1) and the coordinate value X1 in the X direction. And if the mode setting mnemonic lastly read is ChangeRelInt or ChangeRelFix, they instruct to render the horizontal line having the length X1 in the X direction from the start point that is the end point of immediately previous rendered element. Also, if the mode setting mnemonic lastly read is ChangeAbsInt or ChangeAbsFix, they instruct to render the horizontal line in which the start point is the endpoint of immediately previous rendered element and the end point has the Y coordinate equal to that of the start point and the X coordinate value of X1.

VerLineTo_S, VerLineTo_M and VerLineTo_L are codes including the number of arguments (1) and the coordinate value Y1 in the Y direction. And if the mode setting mnemonic lastly read is ChangeRelInt or ChangeRelFix, they instruct to render the vertical line having the length Y1 in the Y direction from the start point that is the end point of immediately previous rendered element. Also, if the mode setting mnemonic lastly read is ChangeAbsInt or ChangeAbsFix, they instruct to render the vertical line, in which the start point is the endpoint of immediately previous rendered element and the end point has the X coordinate equal to that of the start point and the Y coordinate value of Y1.

LineTo_S, LineTo_M and LineTo_L are codes including the number of arguments (2) and one coordinate value (X1,Y1). And if the mode setting mnemonic lastly read is ChangeRelInt or ChangeRelFix, they instruct to render the straight line in which the start point is the end point of immediately previous rendered element and the end point has the coordinate value (X1,Y1) in the relative coordinate from the start point. Also, if the mode setting mnemonic lastly read is ChangeAbsInt or ChangeAbsFix, they instruct to render the straight line in which the start point is the end point of immediately previous rendered element and the end point has the coordinate value (X1,Y1).

ConicCurveTo_S, ConicCurveTo_M and ConicCurveTo_L are codes including the number of arguments (4) and the coordinate values (X1,Y1) and (X2,Y2). And if the mode setting mnemonic lastly read is ChangeRelInt or ChangeRelFix, they instruct to render the secondary Bezier curve in which the start point is the end point of immediately previous rendered element, the control point has the coordinate value (X1,Y1) in the relative coordinate from the start point and the end point has the coordinate value (X2,Y2) in the relative coordinate from the control point. Also, if the mode setting mnemonic lastly read is ChangeAbsInt or ChangeAbsFix, they instruct to render the secondary Bezier curve in which the start point is the end point of immediately previous rendered element, the control point has the coordinate value (X1,Y1) and the end point has the coordinate value (X2,Y2).

CubicCurveTo_S, CubicCurveTo_M and CubicCurveTo_L are codes including the number of arguments (6) and the coordinate values (X1,Y1), (X2,Y2) and (X3,Y3) And if the mode setting mnemonic lastly read is ChangeRelInt or ChangeRelFix, they instruct to render the tertiary Bezier curve in which the start point is the end point of immediately previous rendered element, the first control point has the coordinate value (X1,Y1) in the relative coordinate from the start point, the second control point has the coordinate value (X2,Y2) in the relative coordinate from the first control point, and the end point is the coordinate value (X3,Y3) in the relative coordinate from the second control point. Also, if the mode setting mnemonic lastly read is ChangeAbsInt or ChangeAbsFix, they instruct to render the tertiary Bezier curve in which the start point is the end point of immediately previous rendered element, the first control point has the coordinate value (X1,Y1), the second control point has the coordinate value (X2,Y2) and the end point has the coordinate value (X3,Y3).

Also, in MoveTo_S, HorLineTo_S, VerLineTo_S, LineTo_S, ConicCurveTo_S and CubicCurveTo_S, if the mode setting mnemonic lastly read is ChangeRelInt or ChangeAbsInt, a bit string of 7 bits is employed as the coordinate value. Also, if the mode setting mnemonic lastly read is ChangeRelFix or ChangeAbsFix, a bit string of 3 bits is employed in the integral part as the coordinate value and a bit string of 4 bits is employed in the decimal part.

InMoveTo_M, HorLineTo_M, VerLineTo_M, LineTo_M, ConicCurveTo_M and CubicCurveTo_M, if the mode setting mnemonic lastly read is ChangeRelInt or ChangeAbsInt, a bit string of 10 bits is employed as the coordinate value. Also, if the mode setting mnemonic lastly read is ChangeRelFix or ChangeAbsFix, a bit string of 6 bits is employed in the integral part as the coordinate value and a bit string of 4 bits is employed in the decimal part.

InMoveTo_L, HorLineTo_L, VerLineTo_L, LineTo_L, ConicCurveTo_L and CubicCurveTo_L, if the mode setting mnemonic lastly read is ChangeRelInt or ChangeAbsInt, a bit string of 16 bits is employed as the coordinate value. Also, if the mode setting mnemonic lastly read is ChangeRelFix or ChangeAbsFix, a bit string of 20 bits is employed in the integral part as the coordinate value and a bit string of 4 bits is employed in the decimal part.

The display controller 9 renders a bit map on the display body 10, if the bit map is generated by the CPU 8.

The display body 10 comprises a memorable display body (cholesteric liquid crystal) capable of holding the display contents even if power supply is stopped. And the display body 10 has the display contents rewritten by the rendering operation of the display controller 9.

The bus controller 11 controls the data transfer between the CPU 8 and each of the sections 2 to 12.

The power controller 12 controls the power supply to each of the sections 2 to 12 in the display device 1 in accordance with a command from the CPU 8.

Operation of CPU

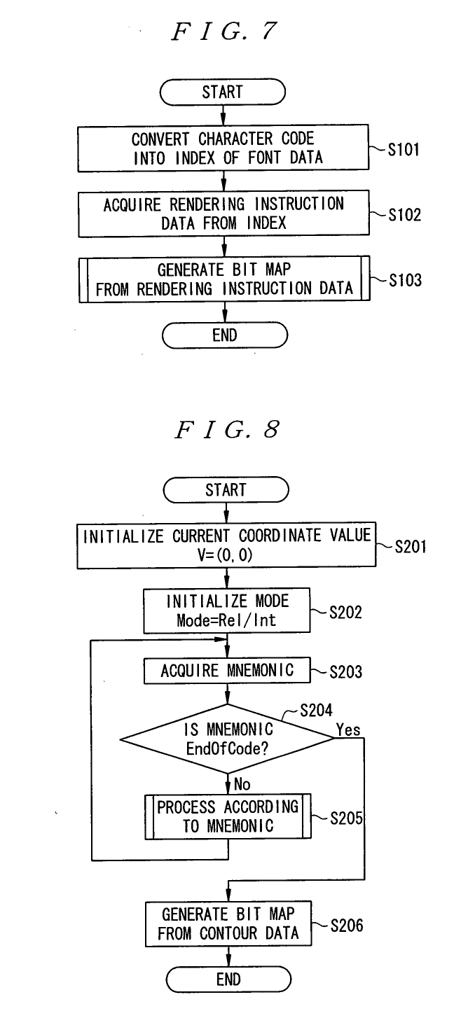

Referring to a flowchart of FIG. 7, a character rendering process performed by the CPU 8 will be described below.

This character rendering process is performed if a character rendering instruction is made. First of all, at step S101, the character code of the rendering instructed character is acquired and converted into the index of font data.

At the next step S102, the rendering instruction data (data composed of a plurality of mnemonics arranged in a prescribed order) are acquired based on the index converted at step S101.

At the next step S103, a bit map generation process (hereinafter described) for generating the bit map of the rendering instructed character is performed based on the rendering instruction data acquired at step S102, and this operation process is ended.

Referring to a flowchart of FIG. 8, the bit map generation process performed at step S103 in the character rendering process will be described below.

In this bit map generation process, at step S201, the coordinate value (current coordinate value) v indicating the pixel of processing object is initialized to (0,0).

At the next step S202, a parameter Mode indicating the rendering mode is initialized to (Rel, Int) (a state where the mode setting mnemonic ChangeRelInt is read).

At the next step S203, one mnemonic is acquired in the prescribed order from the rendering instruction data acquired at step S102.

At the next step S204, it is determined whether or not the mnemonic acquired at step S203 is EndOfCode. And if the mnemonic is EndOfCode (Yes), the procedure goes to step S206, or if the mnemonic is not EndOfCode (No), the procedure goes to step S205.

At step S205, a contour data generation process (hereinafter described) for generating the contour data representing the contour of the rendering instructed character based on the mnemonic acquired at step S203 is performed, and the procedure returns to step S203.

On the other hand, at step S206, the bit map of the rendering instructed character is generated based on the contour data generated at step S205, and this operation process is ended.

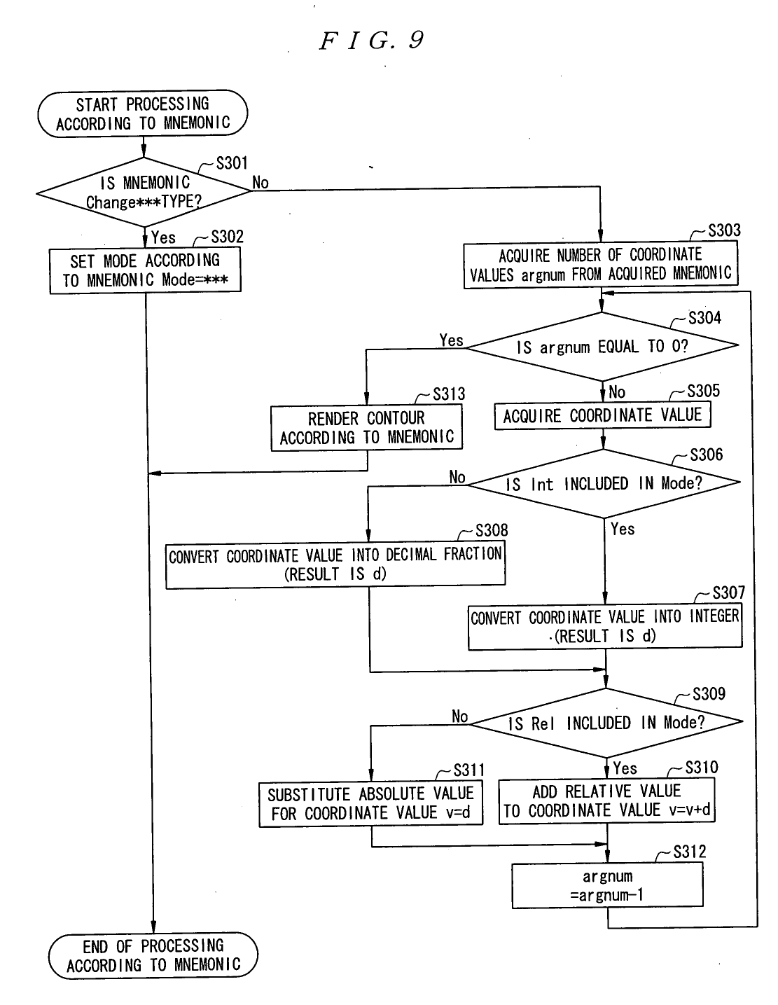

Referring to a flowchart of FIG. 9, the contour data generation process performed at step S205 in the bit map generation process will be described below.

In this contour data generation process, at step S301, it is firstly determined whether or not the mnemonic acquired at step S203 is anyone of ChangeRelInt, ChangeRelFix, ChangeAbsInt, ChangeAbsFix and EndOfCode. If the mnemonic is any one of ChangeRelInt and so on (Yes), the procedure goes to step S302, or if the mnemonic is not anyone of ChangeRelInt and so on (No), the procedure goes to step S303.

At step S302, the parameter Mode is set in accordance with the mnemonic acquired at step S203, and this operation process is ended.

On the other hand, at step S303, the number of arguments is acquired from the mnemonic acquired at step S203, and is made the parameter argnum indicating the number of coordinate values.

At the next step S304, it is determined whether or not the parameter argnum set at step S303 is “0”. And if the parameter argnum is “0” (Yes), the procedure goes to step S313 or the parameter argnum is not “0” (No), the procedure goes to step S305.

At step S305, one coordinate value is acquired in the prescribed order from the mnemonic acquired at step S203.

At the next step S306, it is determined whether or not Int is included in the Mode set at step S302. And if Int is included (Yes), the procedure goes to step S307, or if Int is not included (No), the procedure goes to step S308.

At step S307, the coordinate value (bit string) acquired at step S305 is converted into the integral value d, and the procedure goes to step S309.

On the other hand, at step S308, the coordinate value acquired at step S305 is converted into the decimal value d, and the procedure goes to step S309.

At step S309, it is determined whether or not Rel is included in the Mode set at step S302. And if Rel is included (Yes), the procedure goes to step S310, or if Rel is not included (No), the procedure goes to step S311.

At step S310, the coordinate value d converted at step S307 or S308 is added to the current coordinate value v at present to compute the new current coordinate value v, and the procedure goes to step S312.

On the other hand, at step S311, the coordinate value d converted at step S307 or S308 is made the new current coordinate value v, and the procedure goes to step S312.

At step S312, “1” is subtracted from the parameter argnum to compute the new argnum, and the procedure returns to step S304.

On the other hand, at step S313, the contour data of the rendering instructed character is generated based on the current coordinate value v set successively at step S310 or S311, and this operation process is ended.

If MoveTo is included in the mnemonic acquired at step S203, the coordinate value is only computed, but the contour data of character is not generated.

Operation of Display Device

The operation of the display device 1 according to this embodiment will be described below based on a specific situation.

First of all, suppose that the user performs an operation of instructing the rendering of character and the input section 2 issues a character rendering instruction to the CPU 8. Then, the CPU 8 performs a character rendering process. The character code of the rendering instructed character is firstly acquired and converted into the index of font data at step S101, the rendering instruction data is acquired based on the index at step S102, and a bit map generation process is performed based on the rendering instruction data at step S103, as shown in FIG. 7.

If the bit map generation process is started, the coordinate value (current coordinate value) v indicating the pixel of processing object is initialized to (0,0) at step S201, the parameter Mode indicating the rendering mode is initialized to (Rel,Int) at step S202, one mnemonic is acquired in a prescribed order from the acquired rendering instruction data at S203, the determination at step S204 is “No”, and a contour data generation process is performed based on the acquired mnemonic at step S205.

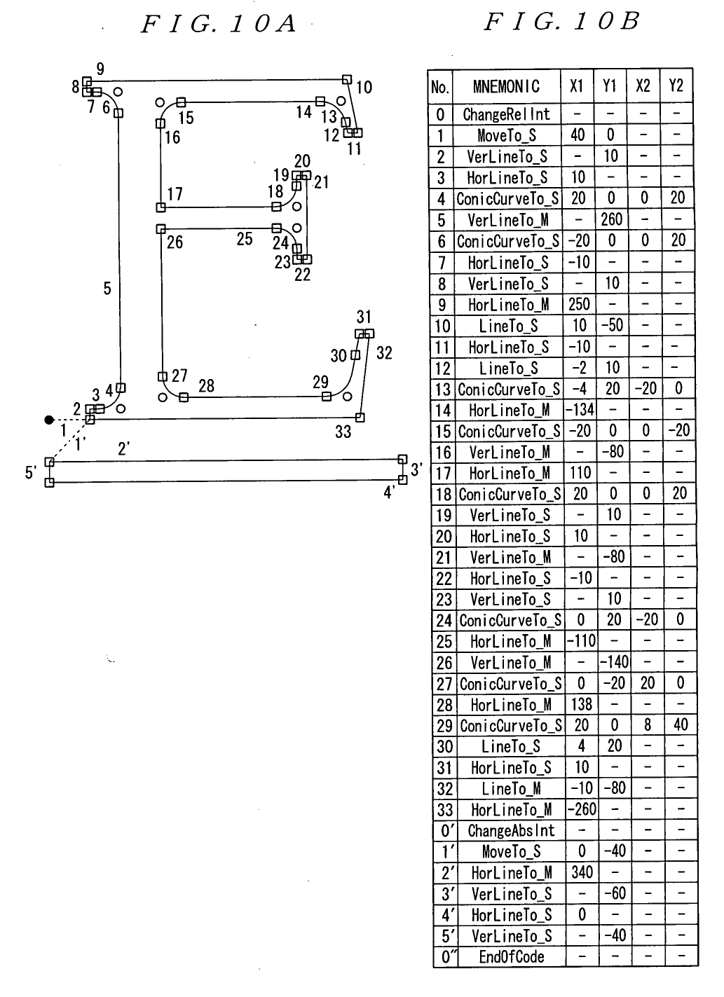

If the acquired mnemonic is ChangeRelInt as shown in FIG. 10, the contour data generation process is performed. As shown in FIG. 9, first of all, the determination at step S301 is “Yes”, the parameter Mode (Rel, Int) is set in accordance with the acquired mnemonic at step S302, and this operation process is ended.

And through the steps S203 and S204, the next mnemonic is acquired, and the contour data generation process is performed based on the mnemonic at step S205.

In the case where the acquired mnemonic is MoveTo_S, if the contour data generation process is performed, the determination at step S301 is “No”, the number of arguments (2) is acquired from the acquired mnemonic and made the parameter argnum indicating the number of coordinate values at step S303, the determination at step S304 is “No”, one coordinate value is acquired in the prescribed order from the acquired mnemonic at step S305, the determination at step S306 is “Yes”, the acquired coordinate value is converted into the integral value d at step S307, the determination at step S309 is “Yes”, the converted coordinate value d is added to the current coordinate value v at present to compute the new current coordinate value v at step S310, “1” is subtracted from the parameter argnum (1) to compute the new argnum (0) at step S312, the determination at step S304 is “Yes”, the step S313 is performed, and this operation process is ended, as shown in FIG. 9.

And through the steps S203 and S204, the next mnemonic is acquired, and the above flow is repeated to generate the character contour data.

Suppose that EndOfCode is acquired while the flow is repeated. Then, the determination at step S204 is “Yes”, the bit map of the rendering instructed character is generated based on the generated contour data at step S206.

And the display controller 9 renders the generated bit map on the display body 10, and displays the rendering instructed character on the display body 10.

In this manner, in the display device of this embodiment, if ChangeRelInt or ChangeRelFix is acquired, the coordinate value included in the later acquired mnemonic is handled as represented in the form of relative coordinate with the coordinate value at the end point of the immediately previous rendered element, and if ChangeAbsInt or ChangeAbsFix is acquired, the coordinate value included in the later acquired mnemonic is handled as represented in the form of absolute coordinate. Also, if ChangeRelInt or ChangeAbsInt is acquired, the coordinate value included in the later acquired mnemonic is handled as represented in the integral part alone, and if ChangeRelFix or ChangeAbsFix is acquired, the coordinate value included in the later acquired mnemonic is handled as represented in a set of the integral part and the decimal part. Therefore, since the mnemonic in which the coordinate value included in the mnemonic is handled as represented in the relative coordinate (or the integral part alone) and the mnemonic in which the coordinate value included in the mnemonic is handled as represented in the absolute coordinate (or the set of the integral part and the decimal part) can be the same, the number of kinds of mnemonics is reduced, so that the compression ratio of the rendering instruction data can be increased.

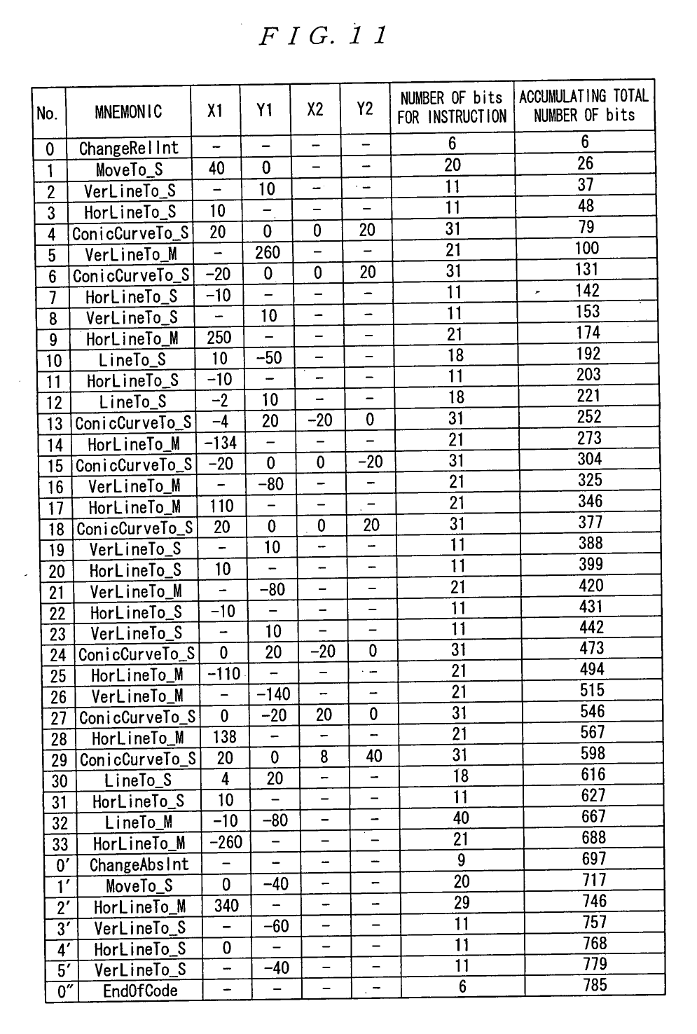

Though the accumulating total number of bits for the rendering instruction data is increased by the amount of mode setting mnemonic by employing the mode setting mnemonic such as ChangeRelInt as shown in FIG. 11, an increase amount in the number of bits is small because typically the frequency of changing the rendering mode is low.

Also, if ChangeRelFix or ChangeAbsFix is acquired, the coordinate value included in the later acquired mnemonic is handled as allocated a more bit width (24 bits) than if ChangeRelInt or ChangeAbsInt is acquired. Therefore, if ChangeRelFix or ChangeAbsFix is acquired before the mnemonic for rending the graphic is acquired, the coordinate value included in the mnemonic can be allocated 24 bits, for example, whereby the intricate rendering can be effected without changing the scaling factor in rending the graphic on the entire display body 10. Also, it is unnecessary that the straight line or Bezier curve is divided, for example, so that an increase in the total number of mnemonics is prevented.

### Second Embodiment

A method for generating the rendering instruction data for use in the display device of the invention will be described below.

Generation Method with ChangeRelInt

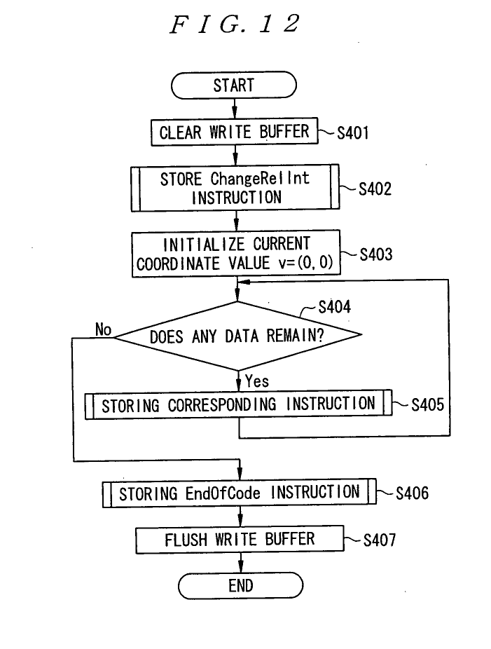

FIG. 12 is a flowchart showing a RelInt rendering instruction generation process for generating the rendering instruction data in which the rendering mode is set in ChangeRelInt.

This RelInt rendering instruction generation process is performed on a computer for rendering instruction generation. At step S401, all the data stored in a write buffer is firstly discarded (the write buffer is cleared).

At the next step S402, ChangeRelInt is stored as the first mnemonic making up the rendering instruction data.

At the next step S403, the current coordinate value v is initialized to (0,0).

At the next step S404, it is determined whether or not any mnemonic used in making up the rendering instruction data remains. And if any mnemonic remains (Yes), the procedure goes to step S405, or if no mnemonic remains (No), the procedure goes to step S406.

At step S405, a RelInt instruction store process (hereinafter described) for storing the data corresponding to the mnemonic, which is determined to remain at step S404, into the write buffer is performed, and the procedure returns to step S404.

On the other hand, EndOfCode is stored as the last mnemonic making up the rendering instruction data at step S406.

At the next step S407, the data stored in the write buffer in the instruction store process at step S405 is outputted as the element making up the rendering instruction data (the write buffer is flushed), and this operation process is ended.

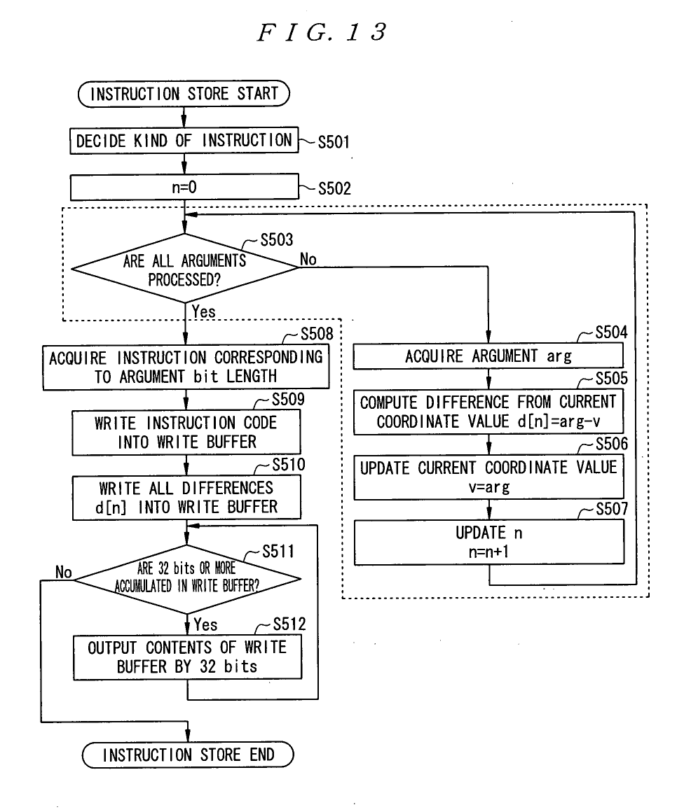

Referring to a flowchart of FIG. 13, the RelInt instruction store process performed at step S405 in the RelInt rendering instruction generation process will be described below.

In this RelInt instruction store process, at step S501, the kind of mnemonic, which is determined to remain at step S404, is firstly decided.

At the next step S502, the variable n is initialized to “0”.

At the next step S503, it is determined whether or not the arguments (e.g., X1, Y1, etc.) of the mnemonic of which the kind is decided at step S501 are all processed through steps S504 to S507 described below. And if all the arguments are processed (Yes), the procedure goes to step S508, or if all the arguments are not processed (No), the procedure goes to step S504.

At the next step S504, the argument arg of the mnemonic of which the kind is decided at step S501 is acquired.

At the next step S505, a difference d[n] from the current coordinate value v is computed.

At the next step S506, the new current coordinate value v is the argument arg acquired at step S504.

At the next step S507, “1” is added to the variable n to compute the new variable n, and the procedure returns to step S503.

On the other hand, at step S508, the instruction corresponding to the argument bit length is acquired.

At the next step S509, the instruction code corresponding to the kind decided at step S501 is stored in the write buffer.

At the next step S510, each difference d[n] computed at step S505 is stored in the write buffer.

At the next step S511, it is determined whether or not the total amount of data stored in the write buffer at step S509 or S510 is greater than or equal to 32 bits. And if the total amount is greater than or equal to 32 bits (Yes), the procedure goes to step S512, or if the total amount is smaller than 32 bits (No), this operation process is ended.

At step S512, the data stored in the write buffer at step S509 or S510 is outputted by 32 bits as the constituent element of the rendering instruction data, and the procedure returns to step S511.

Generation Method with ChangeAbsInt

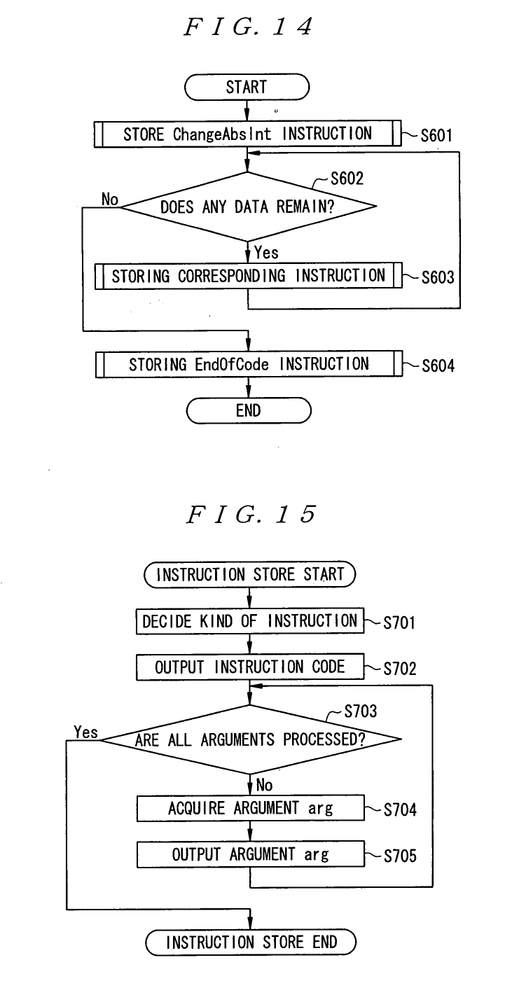

FIG. 14 is a flowchart showing an AbsInt rendering instruction generation process for generating the rendering instruction data in which the rendering mode is set in ChangeAbsInt.

This AbsInt rendering instruction generation process is performed on the computer for rendering instruction generation. At step S601, ChangeAbsInt is firstly stored as the first mnemonic making up the rendering instruction data.

At the next step S602, it is determined whether or not any mnemonic used in making up the rendering instruction data remains. And if any mnemonic remains (Yes), the procedure goes to step S603, or if no mnemonic remains (No), the procedure goes to step S604.

At step S603, an AbsInt instruction store process (hereinafter described) for storing the data corresponding to the mnemonic, which is determined to remain at step S602, into the write buffer is performed, and the procedure returns to step S602.

On the other hand, EndOfCode is stored as the last mnemonic making up the rendering instruction data at step S604, and this operation process is stored.

Referring to a flowchart of FIG. 15, the AbsInt instruction store process performed at step S603 in the AbsInt rendering instruction generation process will be described below.

In this AbsInt instruction store process, at step S701, the kind of mnemonic, which is determined to remain at step S602, is firstly decided.

At the next step S702, the instruction code corresponding to the kind decided at step S701 is stored in the write buffer.

At the next step S703, it is determined whether or not the arguments (e.g., X1, Y1, etc.) of the mnemonic of which the kind is decided at step S701 are all processed at steps S704 and S705 described below. And if all the arguments are processed (Yes), this operation process is ended, or if all the arguments are not processed (No), the procedure goes to step S704.

At the next step S704, the argument arg of the mnemonic of which the kind is decided at step S701 is acquired.

At the next step S705, each argument arg acquired at step S704 is stored in the write buffer, and the procedure returns to step S703.

And through this flow, the rendering instruction data in which the mnemonic for handling the coordinate value in accordance with the rendering mode is arranged after the mode setting mnemonic (ChangeRelInt, ChangeAbsInt) can be generated by performing the RelInt rendering instruction generation process or ChangeAbsInt rendering instruction generation process.

In the above embodiment, the steps S301 and S302 of FIG. 9 constitute a setting function as defined in claims; the steps S306 to S311 of FIG. 9 constitute a display function; the CPU 8 of FIG. 1 and the steps S301 and S302 of FIG. 9 constitute a setting section; and the CPU 8, the display controller 9 and the display body 10 of FIG. 1 and the steps S306 to S311 of FIG. 9 constitute a display section.

Also, the display program, the data structure and the display device of the invention are not limited to the contents of the above embodiment, but various variations may be made without departing from the scope or spirit of the invention.

In the above embodiment, when the mode setting mnemonic (ChangeRelInt, ChangeAbsInt, etc.) is acquired, the coordinate value included in the later acquired mnemonic is handled as represented in any one form of the relative coordinate and the absolute coordinate, but the invention is not limited thereto. For example, the rendering modes may include a mode of handling the newly acquired coordinate value as represented in the low compression coordinate designation (instruction system in which the total of instruction bit length and coordinate bit length of the mnemonic is adjusted to be a multiple of the number of bits easily handled by the software such as 8, 16 or 32) and a mode of handling the newly acquired coordinate value as represented in the high compression coordinate designation (instruction system other than the low compression coordinate designation), and when the specific mode setting mnemonic is acquired, the coordinate value included in the later acquired mnemonic may be handled as represented in anyone form of the low compression coordinate designation and the high compression coordinate designation. In this manner, when the instruction is dynamically generated by software using the low compression coordinate designation, the bit operation is unnecessary, so that the processing can be performed at higher speed.

What is claimed is:

1. A display program for displaying a character by acquiring an instruction for rendering each element composing the character and rendering the element based on the instruction, the program being executed on a computer, characterized by comprising a setting function of setting a method of handling an argument associated with the later acquired instruction in accordance with a rendering mode corresponding to a mode setting instruction if the mode setting instruction for setting the rendering mode is acquired, and a display function of displaying the character by handling the argument in accordance with the setting result by the setting function.

2. The display program according to claim 1, characterized in that the argument is a coordinate value, and the rendering modes include a mode of handling the newly acquired coordinate value as represented in relative coordinate with the coordinate value at an end point of the immediately previous rendered element and a mode of handling the newly acquired coordinate value as represented in absolute coordinate, wherein the setting function involves setting the handling method to handle the coordinate value associated with the later acquired instruction as represented in any one form of the relative coordinate and the absolute coordinate.

3. The display program according to claim 1, characterized in that the argument is the coordinate value, and the rendering modes include a mode of handling the newly acquired coordinate value as represented in the integral part alone, and a mode of handling the newly acquired coordinate value as represented in a set of integral part and decimal part, wherein the setting function involves setting the handling method to handle the coordinate value associated with the later acquired instruction as represented in any one form of the integral part alone and the set of integral part and decimal part.

4. The display program according to claim 3, characterized in that the setting function involves setting the handling method to handle the coordinate value associated with the later acquired instruction to be allocated more bit width when it is handled as represented in the set of integral part and decimal part than when it is handled as represented in the integral part alone.

5. The display program according to claim 1, characterized in that the argument is the coordinate value, and the rendering modes include a mode of handling the newly acquired coordinate value as represented in a low compression coordinate designation, and a mode of handling the newly acquired coordinate value as represented in a high compression coordinate designation, wherein the setting function involves setting the handling method to handle the coordinate value associated with the later acquired instruction as represented in any one form of the low compression coordinate designation and the high compression coordinate designation.

6. A data structure for use in a display program for displaying a character by acquiring an instruction for rendering each element composing the character and rendering the element based on the instruction, characterized in that a mode setting instruction for setting a rendering mode is arranged before the instruction for handling an argument in accordance with the rendering mode.

7. A display device for displaying a character by acquiring an instruction for rendering each element composing the character and rendering the element based on the instruction, characterized by comprising a setting section for setting a method of handling an argument associated with the later acquired instruction in accordance with a rendering mode corresponding to a mode setting instruction if the mode setting instruction for setting the rendering mode is acquired, and a display section of displaying the character by handling the argument in accordance with the setting result by the setting section.
